(19) United States
(12) Patent Application Publication
(10) Pub. No.: US 2018/0352392 A1
(43) Pub. Date: Dec. 6, 2018

(54) SYSTEM AND APPLICATION FOR THE COMUNICATION BETWEEN AND MONITORING OF MULTIPLE USERS

(71) Applicants: KYLE PENWELL, BLOSSOM, TX (US); LACY PENWELL, BLOSSOM, TX (US)

(72) Inventors: KYLE PENWELL, BLOSSOM, TX (US); LACY PENWELL, BLOSSOM, TX (US)

(21) Appl. No.: 15/608,307

(22) Filed: May 30, 2017

(51) Int. Cl. H04W 4/14; H04W 4/02; G08B 21/02; H04M 1/725

(52) U.S. Cl. CPC H04W 4/14; H04M 1/72572; G08B 21/0283; H04W 4/02

(57) ABSTRACT

A system for communicating between multiple users is shown and described. The system monitors the location of each remote device and permits communications there between. The system includes a personal electronic device configured to include a processor and an input/output interface. The input/output interface is configured to transmit and receive electronic data. The processor is configured to process the electronic data according to one or more parameters. Further included is a plurality of remote devices including electronic hardware to permit the transmission and reception of electronic data with the personal electronic device. The plurality of remote devices are in communication with one another so as to transmit and receive electronic data between each of them. Personal electronic device monitors the activity of remote devices but is not necessary for communication between devices. Remote devices may communicate to one another independent of the personal electronic device.

### BACKGROUND

### 1. Field of the Invention

The present application relates to a system for communicating, and more particularly to an electronic device and associated wearable technology to communicate between each other for the safety, security, and location or multiple users.

### 2. Description of Related Art

Association in groups is a natural tendency among people. It could be said that much of ones fondest moments involve other people. Communication between people in groups can become difficult when the groups spread out. When distance between members of a group become significant enough, locating each member of the group also becomes difficult. Modern day communication methods can assist in communicating between members in selected environments, however they are not ideally used in all situations. For example, fear of damaging an electronic device in water (i.e. water parks) can lead one to not use the device. Selected work environments may not be suitable for personal electronic devices either. Beyond just communicating, the ability of locating in real time each individual in a group or party of people is almost impossible.

Individuals in groups can get lost from one another in busy or high trafficked areas. For example, a child may get lost from his/her family at a theme park. The child may not be old enough to use a personal electronic device to communicate with the family. Even if a personal electronic device was accessible to the child, determining his/her location may be difficult.

Presently when large groups are together a general protocol is to either stick together to avoid losing anyone, or if the group disperses, a specific time is set to arrive back at a particular location. Between separating and the time of meeting members of the group are unable to determine where the others have gone or are at without modern communication methods, such as text, calling, and email.

Although strides have been made in communication devices, shortcomings remain with respect to communicating and locating between members when dispersed. A new system is needed to permit multiple users the ability to more efficiently communicate and locate one another in high traffic areas without the need to monitor a personal electronic device such as a cell phone or tablet.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a system for communicating between multiple users according to an embodiment of the present application.

FIG. 2 is a exemplary schematic of electronic components used in the system for communicating between multiple users as seen in FIG. 1.

FIG. 3 is a schematic of the devices within system for communicating between multiple users as seen in FIG. 1.

FIG. 4 is an exemplary perspective view of a portable communicator for use in the system for communicating between multiple users of FIG. 1.

FIG. 5 is a bottom view of the portable communicator of FIG. 4.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of an embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with traditional communication and locating methods. In particular, the system is configured to assist in the safety, security, and location of group member in any given location. The system is particularly useful in high traffic establishments, such as water parks and amusement parks with many children and adolescents. Other locations may be in retail outlets or large meeting locations. The system is configured to track the location of each user through an electronic device and to permit reminder notifications, selected communications, and updates for each user through wearable technology devices. Each of the functions is operable without the need to view or handle the personal electronic device in real time. These and other unique features of the device are discussed below and illustrated in the accompanying drawings.

The system and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The system includes a personal electronic device configured to process and store information. The personal electronic device is configured to transmit and receive electronic data between one or more devices. The system further includes one or more remote electronic devices (i.e. wearable technology) configured to travel with and be in communication with each user. The wearable device is configured to transmit and receive electronic data with the personal electronic device. The electronic data is configured to include location data of each user and notification data to allow communication between users. Additional features and functions of the device are illustrated and discussed below.

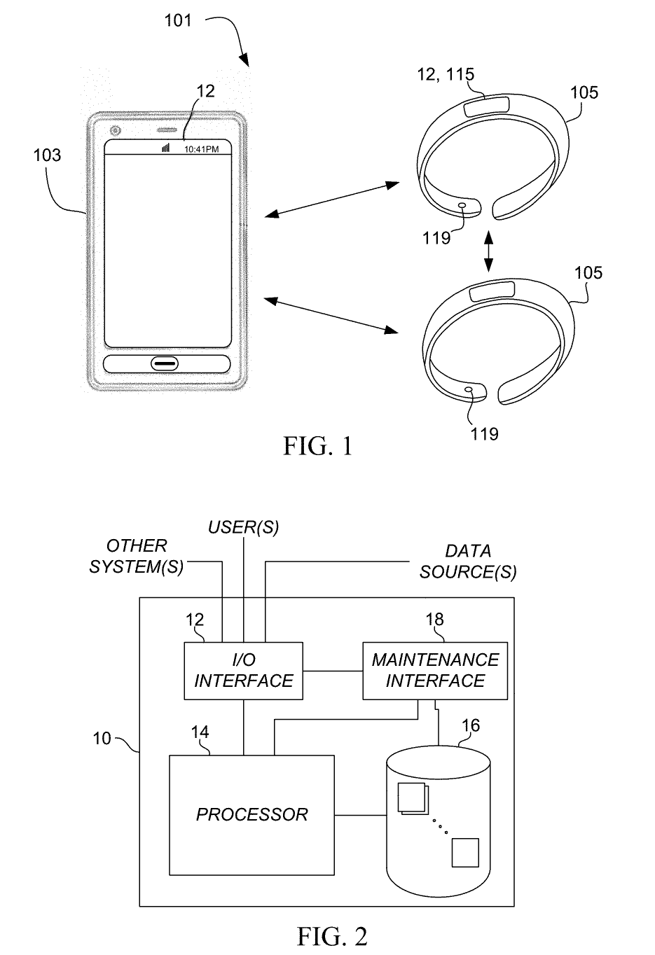

Referring now to the drawings wherein like reference characters identify corresponding or similar elements in form and function throughout the several views. FIG. 1 illustrates a system for communicating between multiple users 101. System 101 includes a personal electronic device 103 configured to include a processor and an input/output interface. The input/output interface is configured to transmit and receive electronic data. The processor is configured to process the electronic data according to one or more parameters. Further included is a plurality of remote devices 105 including electronic hardware to permit the transmission and reception of the electronic data with the personal electronic device. The plurality of remote devices 105 are in communication with one another so as to transmit and receive electronic data between each of them. Devices 105 are configured to provide notifications there between in relation to at least one of time, location, and messages. Personal electronic device 103 monitors the activity of devices 105 but is not necessary for communication between devices 105. Devices 105 may communicate to one another independent of device 103.

Both personal electronic device 103 and remote devices 105 are electronic devices that are configured to process selected data and permit the transmission and reception of electronic data. Therefore, as communication and processing is performed within each device 103 and 105, each includes a computing system. The manner in which each device functions is described more accurately by referencing FIG. 2.

Referring now also to FIG. 2 in the drawings, a schematic of an exemplary computing system for use in devices 103 and 105 of system 101 is illustrated. As stated previously, the functions and features of both devices 103 and 105 may be equally represented herein. FIG. 2 illustrates an exemplary set of components used to facilitate transmission/reception of data, the processing and analysis of such data, and the ability to permit a user to engage each device. Schematic 199 includes a computing system 10.

The computing system 10 includes an input/output (I/O) interface 12, an processor 14, a database 16, and a maintenance interface 18. Alternative embodiments can combine or distribute the input/output (I/O) interface 12, processor 14, database 16, and maintenance interface 18 as desired. Embodiments of the computing system 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the computing system 10. The I/O interface 12 can be configured for allowing one or more users to input information to the computing system 10 via any known input device. Examples can include a keyboard, mouse, touch screen, microphone, and/or any other desired input device. The I/O interface 12 can be configured for allowing one or more users to receive information output from the computing system 10 via any known output device. Examples can include a display monitor, a printer, a speaker, and/or any other desired output device. The I/O interface 12 can be configured for allowing other systems to communicate with the computing system 10. For example, the I/O interface 12 can allow one or more remote computer(s) to access information, input information, and/or remotely instruct the computing system 10 to perform one or more of the tasks described herein. The I/O interface 12 can be configured for allowing communication with one or more remote data sources. For example, the I/O interface 12 can allow one or more remote data source(s) to access information, input information, and/or remotely instruct the computing system 10 to perform one or more of the tasks described herein.

The database 16 provides persistent data storage for computing system 10. While the term “database” is primarily used, a memory or other suitable data storage arrangement may provide the functionality of the database 16. In alternative embodiments, the database 16 can be integral to or separate from the computing system 10 and can operate on one or more computers. The database 16 preferably provides non-volatile data storage for any information suitable to support the operation of the computing system 10, including various types of data discussed below.

The maintenance interface 18 is configured to allow users to maintain desired operation of the computing system 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, linking multiple devices, and/or performing data backup operations. In some embodiments, the maintenance interface 18 can be configured to allow for maintenance of the processor 14 and/or the I/O interface 12. This can include, for example, software updates and/or administrative tasks such as security management and/or adjustment of certain tolerance settings.

The processor 14 is configured receive communication data from one or more sources and process that data according to one or more user parameters. Examples of parameters could be limitations, warnings, time related functions, spatial restrictions such as location limitations, and so forth. The processor 14 can include various combinations of one or more computing systems, memories, and software components to accomplish these tasks and functions.

As seen in FIG. 1, the personal electronic device 103 is illustrated as a cellular phone. Other examples of suitable devices are understood to exist and system 101 is not herein limited to device 103 being only as depicted. Additionally, devices 105 are ideally wearable technology devices. These devices are configured for easy transportation with an individual user. To best facilitate communication and all functions of system 101, it is preferred that device 105 be in contact with the user/wearer. Although multiple methods of accomplishing this is possible, one particular method appears simple. In the present discussion, the remote wearable technology devices 105 of system 101 are depicted and described as wrist bands. This allows them to be in constant contact with the user and able to feel, see, and engage with device 105 at any time with the least amount of obstruction or interference.

Device 103 is configured to communicate with each device 105 within system 101. Any number of devices 105 are possible. Once each device 105 is paired/synced/linked with device 103, the device is ready for use. Device 103 is configured to systematically track and monitor the location of each remote device 105 and the amount of communications there between. Device 103 may send out communications to one or more remote devices 105 as instructed at a particular time or as programmed. For example, a parent may use remote devices 105 with her children at a theme park. Each device 105 is synced with device 103 and is now being monitored. Because each device 103/105 is synced, electronic data is able to be exchanged. Messages may be sent from device 103 to any of the remote devices 105 at a prescheduled time (i.e. time to eat and meet up), or a message may be manually sent at any time by the parent by accessing device 103 and manually sending a message.

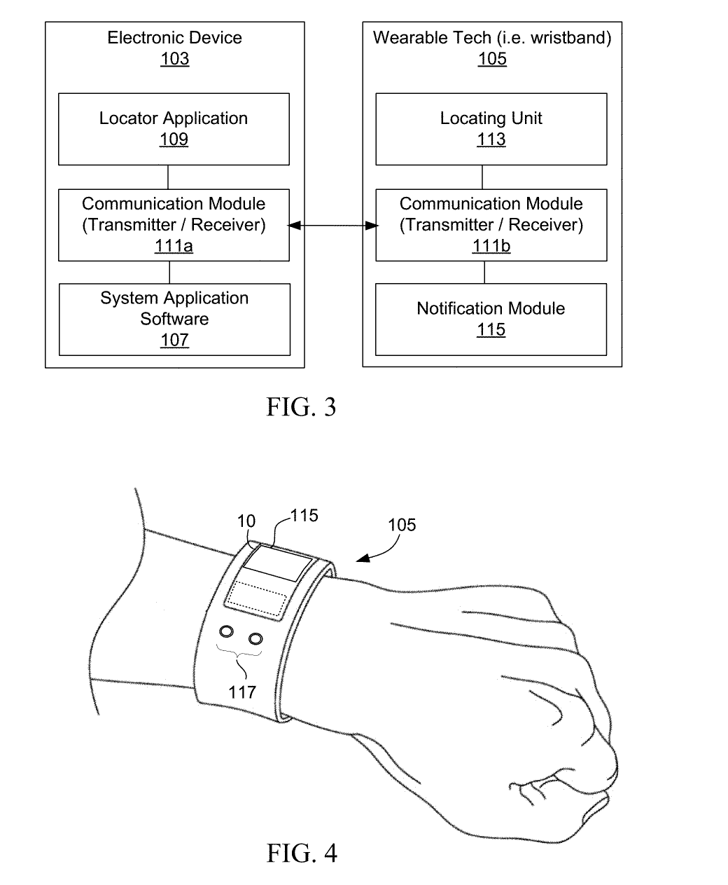

Referring now to FIG. 3 in the drawings, a schematic of the functions of the devices in system 101 is illustrated. Device 103 includes a system application software 107, a locator application 109, and a communication module 111a. Application software 107 is executable code that is operable in system 10 of device 103. The integration of software application 107 on device 103 acts to make device 103 as an administrative device or base unit for system 101. Software application 107 is downloadable onto device 103 or any personal electronic device so as to allow it to function with remote devices 105. A remote device 105 may also be paired with device 103 and set up to be an administrative device 105. Ideally this may be with some user, such as a parent. As an administrative remote device, the parent can operate system 101 without the need to engage device 103.

Application software 107 is designed to provide a user (i.e. parent) selected options and parameters in the performance and function of system 101. Selected parameters related to any of the following: location information, messages/notifications, geographic data of an area and so forth are conceivable. Device 103 further includes location application 109 that is configured to track/monitor the location of each remote device 105 and compare that with its own location. Additionally device 103 includes a communication module 111a configured to transmit and receive electronic data from remote devices 105.

Remote devices 105 include similar functioning components to that of device 103. Remote devices 105 includes at least a locating unit 113 and a notification module 115. Locating unit 113 is configured to monitor the location of the remote device to which it is associated with. The level of detail and accuracy should be sufficient to isolate a user within a pretty fair degree of accuracy. Locating unit 113 is similar to that of location tracking devices similar in the market. For example, unit 113 may be a short range GPS unit. Although long range is possible, short ranges are preferred as excessive distances between device 103 and remote device 105 are not anticipates. Additionally, it is preferred to keep the structure compact and maximize battery life. The location of is sent from unit 113, through module 111b, to device 103 for monitoring.

Notification module 115 is similar to that of input/output interface 12. Module 115 is an interface that allows a user of the remote device to receive, generate, and interpret communications. Communication module 111b is located on remote device 105 to send and receive electronic data with device 103 and between other remote devices. Communications may be sent from and received through module 115 in many different forms. For example, messages or notifications may be generated or received in the form of audible sounds, visual cues (i.e. text and colors), and sensory methods (i.e. vibration).

In use, a user is able to adjust parameters on device 103 and apply or transmit them to each remote device 105. The ability to adjust parameters allows the user full control of system 101 so as to provide a desired level of performance. The parameters may be adjusted at any time during use. Any need to re-sync may occur wirelessly through communication modules 111a/111b. The following examples are provided to give perspective of the functions of system 101.

For example, a user may select a permitted safe distance in which remote devices 105 may be separated from device 103. As unit 113 tracks the location of each respective remote device in real time, module 111b is configured to transmit that location back to module 111a for processing and monitoring. The user may set a predetermined spatial limit top ensure that users of remote devices 105 do not go too far away. For instance, if a user of a particular remote device travels more than 0.5 miles away from device 103 or an administrative remote device, wherein the distance limit parameter was set at less than 0.5 miles, the particular remote device produces a notification to the user that her/she is too far away. The location of the administrative device/device 103 may be provided to guide the user back within a safe distance. Simultaneously, device 103 and/or the administrative remote device may also generate a notification alerting the parent of the position of that particular remote device. The notifications may be generated by either device 103 or remote devices 105. In some situations, remote devices 105 are configured to monitor the location of device 103 and/or the administrative remote device.

In another example, a user may select either standard messages or custom messages to be sent out at preselected times. Either one or both of devices 103/105 may be configured to track time. When a particular time is reached, a message may be transmitted from any device within system 101 to any other device within system 101. The nature, time, and frequency of such messages may be custom tailored by a user. The messages may be standard in that they are pre-stored in the application software or may be customized. Naturally, any of the devices may communicate at any time upon request of a user with its respective interface.

A further feature is that a user may optionally set parameters differently between the remote devices 105. A parent may wish to maintain a little more control for younger children compared to older members of the family, for example. Although these are not the only features and functions of device 103, these are examples. Device 103 may be fully customized in relation to communications and geographical limitations for any and all remote devices.

A particular advantage of system 101 is that device 103 is not necessary to be used for remote devices to function. For instance, once remote devices 105 are synced together and any particular parameters are set, device 103 may be placed away in a bag or other safe place. Communications between remote devices will continue to happen as desired. Any new communications may be sent in real time from one remote device to any other remote device. This helps to keep device 103 protected in environments where it is not suitable for use or may be unsafe. Additionally this helps as a power saving feature of device 103. Because each remote device 105 is synced with a particular device 103, a network is formed to restrict communications to be only with other devices in that network.

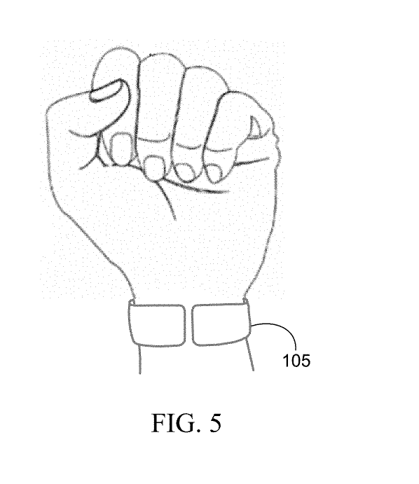

Referring now to FIGS. 4 and 5 in the drawings, assorted views of remote device 105 on a user is illustrated. Device 105 includes an interface that has module 115 and optionally a secondary input unit 117. Input units 117 may serve several functions, for instance they may help navigate module 115, select amongst functions, send emergency signals or messages, and so forth. Unit 117 may be a button, knob, sensor, dial, or any other mechanical or electronic component.

As noted previously, each of the devices of system 101 are electronic and therefore require an electrical charge to operate. Each device is configured to include a portable power source to provide a continuous level of power to permit operation. Devices 105 may include a charging port 119 to permit recharging. Also of note is that each of the devices may be configured to operate over any type of wireless communication method. For example, Bluetooth®, wireless networks, satellite, and so forth are possible. Additionally, hot spot wireless communication networks established by a particular entity or location (i.e. theme park) may also be used. Furthermore it should be understood that system 101 is not limited to only large theme parks but is usable in small groups and remote locations, such as parks, grocery stores, and so forth.

The current application has many advantages over the prior art including at least the following: (1) remote communication between users without the need of a personal electronic device; (2) customizable parameters for operation; and (3) location monitoring of each remote device.

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A communication and location monitoring system for remote users, comprising:
a portable personal electronic device configured to include a processor and an input/output interface, the input/output interface to transmit and receive electronic data, and the processor configured to process the electronic data according to one or more parameters; and
a plurality of remote devices including electronic hardware to permit the transmission and reception of the electronic data with the personal electronic device, the plurality of remote devices in communication with one another so as to transmit and receive electronic data between them independent of the personal electronic device, the plurality of remote devices being initially linked together via the personal electronic device, the plurality of remote devices configured to provide notifications there between in relation to at least one of time, location, and messages, the plurality of remote devices configured to be worn by a user;
wherein the personal electronic device is configured to monitor the activity of each of the plurality of remote devices, the plurality of remote devices able to communicate to one another devoid of user interaction with the personal electronic device through a non-cellular wireless network; and
wherein one of the plurality of remote devices is selectively designated as an administrative remote device by the personal electronic device, the administrative remote device configured to regulate the transmission of communication amongst the remaining plurality of remote devices separate from the personal electronic device.

2. The system of claim 1, wherein the plurality of remote devices is waterproof.

3. The system of claim 1, wherein the plurality of remote devices is rechargeable.

4. The system of claim 1, wherein the plurality of remote devices are configured to communicate the notifications via visual methods.

5. The system of claim 1, wherein the plurality of remote devices are configured to communicate the notifications via visual audible.

6. The system of claim 1, wherein the plurality of remote devices are configured to communicate the notifications via sensory methods.

7. The system of claim 1, wherein the plurality of remote devices is configured to monitor the location of the users in real time.

8. The system of claim 1, wherein at least one of the plurality of remote devices is configured to generate a notification in response to the location of one of the plurality of remote devices.

9. (canceled)

10. The system of claim 1, wherein the plurality of remote devices includes a user interface configured to display and generate communication between each other.

11. The system of claim 1, wherein the personal electronic device is configured to be synced with each of the plurality of remote devices.

12. The system of claim 1, wherein the parameters of the personal electronic device are modifiable by a user to suit desired preferences.

13. The system of claim 12, wherein the parameters between two or more of the plurality of remote devices are different.

14. The system of claim 1, wherein the personal electronic device includes a software application configured to facilitate communication and monitoring of the plurality of remote devices.
